(19) United States
(12) Patent Application Publication
(10) Pub. No.: US 2015/0089423 A1
(43) Pub. Date: Mar. 26, 2015

(54) Geographically Selective Maritime Messaging

(71) Applicant: Robert John Tenetylo, Snoqualmie, WA (US)

(72) Inventor: Robert John Tenetylo, Snoqualmie, WA (US)

(21) Appl. No.: 14/034,537

(22) Filed: Sep. 23, 2013

(51) Int. Cl. G06F 3/0484; H04B 7/26; G06F 3/0481

(52) U.S. Cl. CPC G06F 3/04842; G06F 3/04817; H04B 7/26
USPC 715/771

(57) ABSTRACT

A process for initiating maritime radio communication, directed toward the recipient vessel's location, and exclusive of all other vessels outside the geographically-defined box. An airborne electro-optical or infrared sensor detects the presence of vessels in the maritime domain. Established geolocation techniques are employed to determine the approximate geographical location (latitude and longitude) of the target vessel. The derived geographical location of the target vessel is used to encode a Digital Selective Calling (DSC) Geographical Area Call, in the Very High Frequency (VHF) band, for the purpose of establishing radio communications. The process allows for geographically selective communications without previous knowledge of the target vessel's Maritime Mobile Service Identity (MMSI) and without the target vessel's assistance in determining its geographical location.

### CROSS-REFERENCE TO RELATED APPLICATIONS

Not Applicable.

### STATEMENT REGARDING FEDERALLY SPONSORED RESEARCH OR DEVELOPMENT

No Federal funding was used in the research or development of this invention.

### REFERENCE TO SEQUENCE LISTING, TABLE, OR COMPUTER PROGRAM LISTING COMPACT DISC APPENDIX

Not Applicable.

### BACKGROUND OF THE INVENTION

1. Field of the Invention 340/825.341 Communications, electrical. Digital and selective based on the geographical location (latitude and longitude) of the receiving maritime vessel. This process facilitates radio communication and has applications in maritime search and rescue, collision avoidance, port security, and maritime domain awareness.

2. Description of Related Art

Digital Selective Calling (DSC) is an integral part of the Global Maritime Distress Safety System (GMDSS). Geographical Area Calling is one of many types of DSC calls. DSC protocols for Geographical Area Calls are set forth in the International Telecommunications Union's ITU-R M.493 (series). Vessels with DSC-capable radios, if properly interfaced with a Global Positioning System (GPS) receiver, will process incoming Geographic Area Calls when the vessel is within a prescribed geographical “box,” defined in latitude and longitude by the calling party's encoded DSC transmission. If outside this defined geographical box, a vessel's radio will not process the incoming Geographical Area Call and nothing will be heard by the operator. The Federal Communications Commission (FCC) requires that all marine radios manufactured after June, 2000 have at least minimal DSC capabilities.

Numerous maritime port surveillance systems exist that utilize optical sensors to detect and track vessels. The problem with these systems is the inability to directly establish radio communications with any vessel the optical sensor detects. A broadcast on the Very High Frequency (VHF) distress frequency, channel 16, is generally the only means to establish radio communications with subject vessels. The present invention defines a process that combines established DSC Geographical Area Call formatting with existing geolocation technology using Electro-Optical (EO) or Infrared (IR) sensors in a unique way to enable geographically selective radio contact with any DSC-capable vessel.

Hiraoka [US 2009/0079590 A1] discloses a method to display the location of a vessel based on received DSC or Automatic Identification System (AIS) transmissions from the vessel. The method described by Hiraoka requires that the subject vessel make its position known by actively transmitting positional reports via DSC or AIS radio transmissions. In Hiraoka, the subject vessel is a willing and active participant in determining its geolocation. The present invention defines a process in which the subject vessel's position is determined without that vessel's knowledge or participation. Furthermore, this invention describes a process where radio communications are established without the subject vessel broadcasting its position via DSC or AIS transmissions. The present invention has no requirement that the subject vessel will assist the sender in determining its geolocation.

Sundoro [US 2010/0099386 A1] describes a method of storing and transmitting a pre-recorded voice message to a selected vessel after radio communications are established using a DSC Individual Call. A DSC Individual Call achieves the desired selectivity by encoding the subject vessel's Maritime Mobile Service Identity (MMSI) in the DSC transmission. A MMSI is a 9-digit identification number, similar to a telephone number, and unique to a specific vessel or group of vessels. Only the subject vessel's DSC radio will decode the sender's DSC Individual Call transmission. The process described in Sundoro does not require that the sender determine the geographical location of the subject vessel, only that its MMSI is known and that the subject vessel is within range of the DSC transmission (roughly 20 miles depending on antennae heights and transmit power). The present invention employs a completely different type of DSC call; the Geographical Area Call. A DSC Geographical Area Call achieves the desired selectivity by encoding the subject vessel's approximate position (latitude and longitude) in the transmission. Only installed DSC radios within the designated “call box” will decode the transmission. The present invention does not require knowledge of the subject vessel's MMSI to establish radio communications.

### BRIEF SUMMARY OF THE INVENTION

The present invention defines a process that combines DSC Geographical Area Call functionality with existing geolocation techniques using a EO/IR sensor systems in a unique way to enable selective radio contact with vessels equipped with a DSC radio. EO/IR sensors mounted on an aerial platform detect vessels in the maritime environment. Video images of a subject vessels and the vessel's geographical location, in latitude and longitude coordinates, are sent to a processor and displayed on a Human/Machine Interface (HMI) display. Upon receiving a user command from the HMI, either manually entered or when operating in autonomous mode, the Geographically Selective Maritime Messaging (GSMM) module formats a DSC Geographical Area Call encoded with the subject vessel's estimated latitude and longitude coordinates in accordance with International Telecommunications Union formatting protocol. The DSC Geographical Area Call sequence modulates a VHF carrier frequency and is transmitted over the air. The subject vessel's DSC radio, being within the prescribed “call box,” will decode the transmission and alert the vessel's radio operator that a caller is attempting to establishing radio communications. Selectivity is accomplished as the entire process is transparent to operators of vessels outside of the geographical call box since their DSC radios will not decode the transmission or provide an audible alert. In summary, this invention defines a process for initiating radio communications with selected vessels without prior knowledge of the subject vessel's MMSI and without the subject vessel's assistance in determining its geographical location.

### BRIEF DESCRIPTION OF DRAWINGS

FIG. 1 is a functional block diagram of the overall Geographically Selective Maritime Messaging (GSMM) process

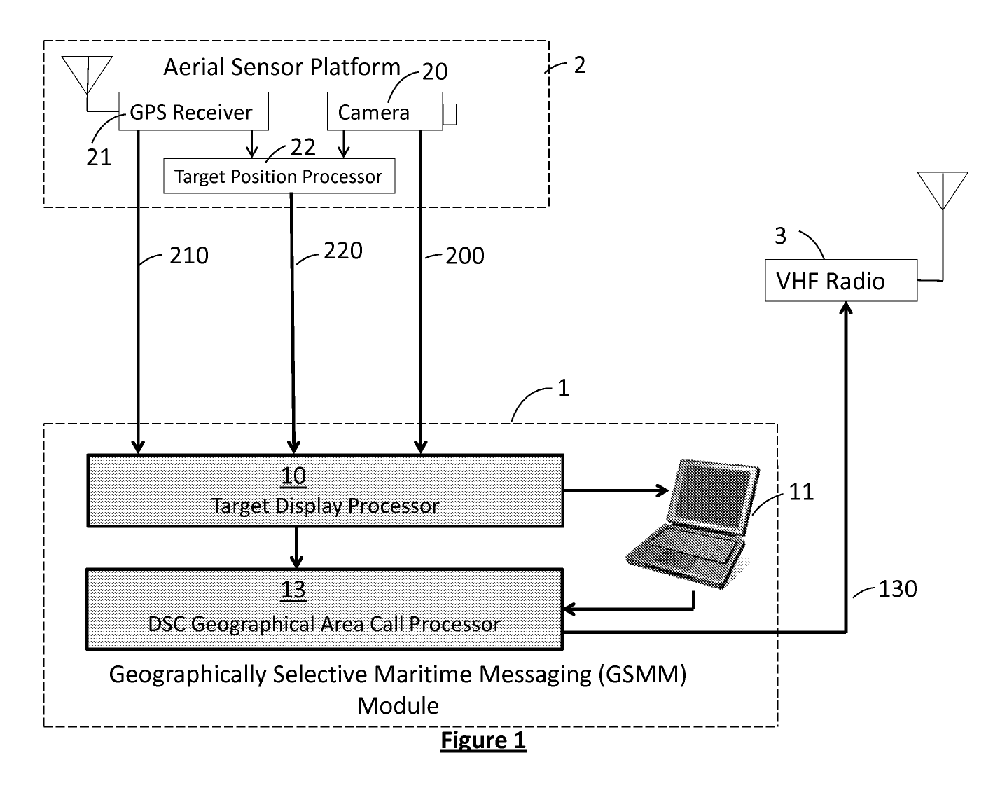

FIG. 2 is a block diagram of the GSMM module

FIG. 3 is a block diagram of the aerial sensor platform

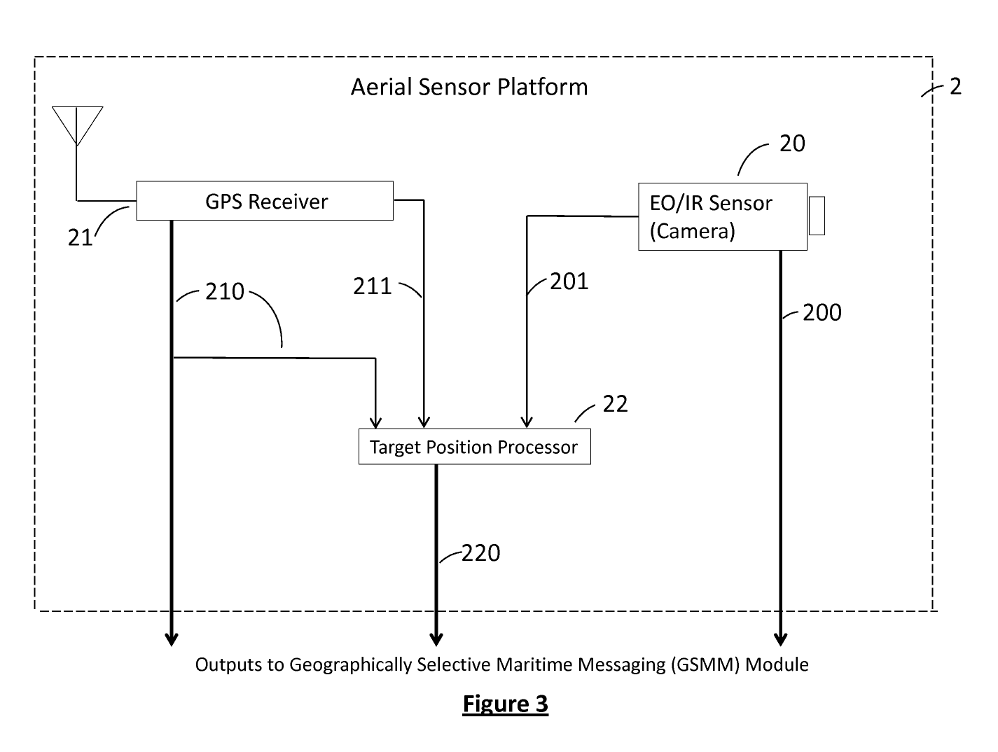

FIG. 4 is the Human Machine Interface (HMI) display screen

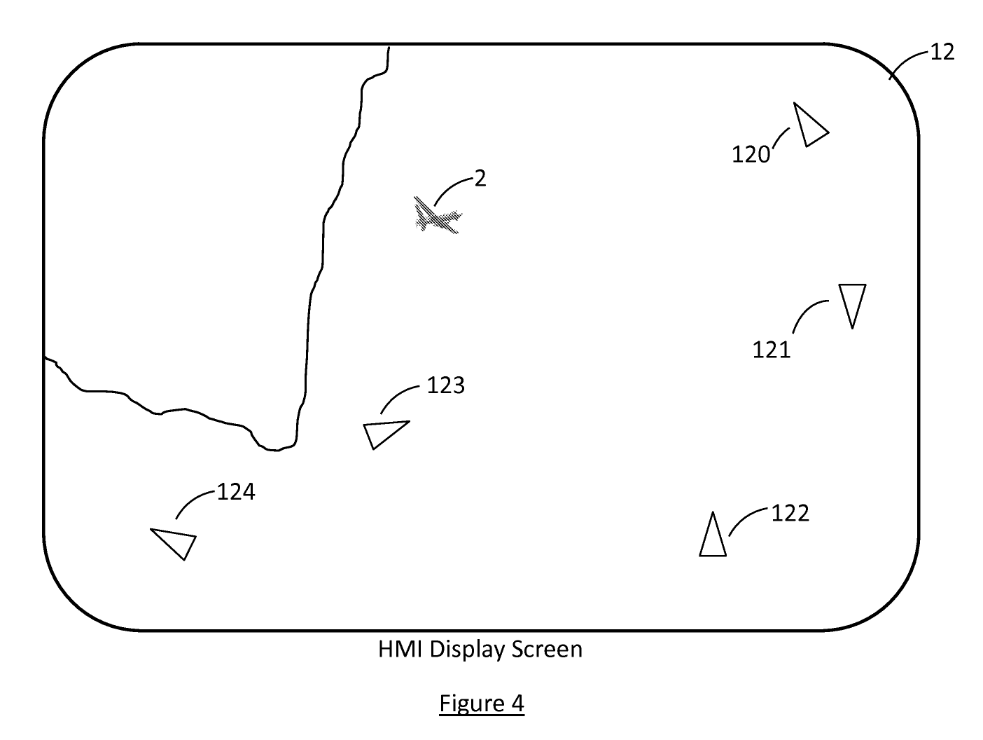

FIG. 5 is a flow diagram of the preferred embodiment of the process of the invention

FIG. 6 is the format of a DSC Geographical Area Call (From ITU-R M.493)

### INDEX TO THE REFERENCE NUMERALS

1 Geographically Selective Maritime Messaging Module
2 Aerial Sensor Platform
3 Very High Frequency (VHF) Radio Transceiver
10 Target Display Processor
11 Human Machine Interface (HMI)
12 HMI Display
13 DSC Geographical Area Call Processor
20 Camera, Electro-Optical or Infrared sensor
21 Global Positioning System (GPS) Receiver and antenna
22 Target Position Processor
100 Target Display Video
101 Target Geographical Location Information, Latitude/Longitude
110 User Commands
120-124 Target Vessels
130 DSC Geographical Area Call—Audio Tones
200 Target Video
201 Geolocation Data—Azimuth and Laser Range Finder (LRF)
210 Geolocation Data—Latitude/Longitude of Aerial Sensor Platform
211 Geolocation Data—Altitude of Aerial Sensor Platform
220 Geolocation Data—Latitude/Longitude of Target

### DETAILED DESCRIPTION OF THE INVENTION

A process described that employs the derived geographical coordinates of OE/IR sensed maritime vessels to initiate radio communications through pre-formatted digital packets. Although all equipment shown in the figures will be described in detail to provide context, only the Geographically Selective Maritime Messaging Module 1 is essential to the process for which a patent is sought. The aerial sensor platform 2 and VHF radio 3 are ancillary equipment and not essential to the process for which a patent is being sought.

The aerial sensor platform 2 can be any elevated structure or airframe comprised of Electro-Optical or Infrared sensing equipment 20, Global Positioning System (GPS) receiver and antenna 21, and target position processor 22. Aerial sensor platforms 2 include, but not limited to, unmanned aerial vehicles (UAV), aerostat, blimp, or tower structure. The aerial sensor platform 2 provides an unobstructed view of the surrounding maritime environment below. The EO/IR sensor 20 provides raw video 200 of detected vessels to the Target Display Processor 10 of the GSMM Module 1. The EO/IR sensor 20 also provides a signal 201 to the Target Position Processor 22 for the purpose of determining the approximate geographical position, in latitude and longitude, of objects in the sensor's field of vision. Signal 201 consists of the azimuth angle of the sensor's lens and Laser Range Finder (LRF) measurement to the target vessel. The aerial sensor platform's onboard GPS receiver 21 provides the platform's own geographical position, in latitude and longitude, as signal 210 internally to the Target Position Processor 22 for the purpose of target vessel geolocation. The GPS receiver 21 also provides signal 210 externally to the Target Display Processor 10 of the GSMM Module 1 for the purpose of displaying the aerial platform's geographical position on the HMI Display 12. The GPS receiver 21 also provides signal 211, altitude or height above ground, internally to the Target Position Processor 22 for the purpose of target vessel geolocation. Since the location and altitude of the aerial sensor platform are known, as well as azimuth angle and range to the target vessel, by applying mathematical formulas the target vessel's geographical location can readily be determined. In other words, if two sides (platform altitude and distance to target) of a triangle are known, the length of the third side can be determined. This is the function of the Target Position Processor 22. The target vessel's derived geographical location, in degrees of latitude and longitude, is provided as an output of the Target Position Processor 22 as signal 220 to the Target Display Processor 10 of the GSMM Module 1.

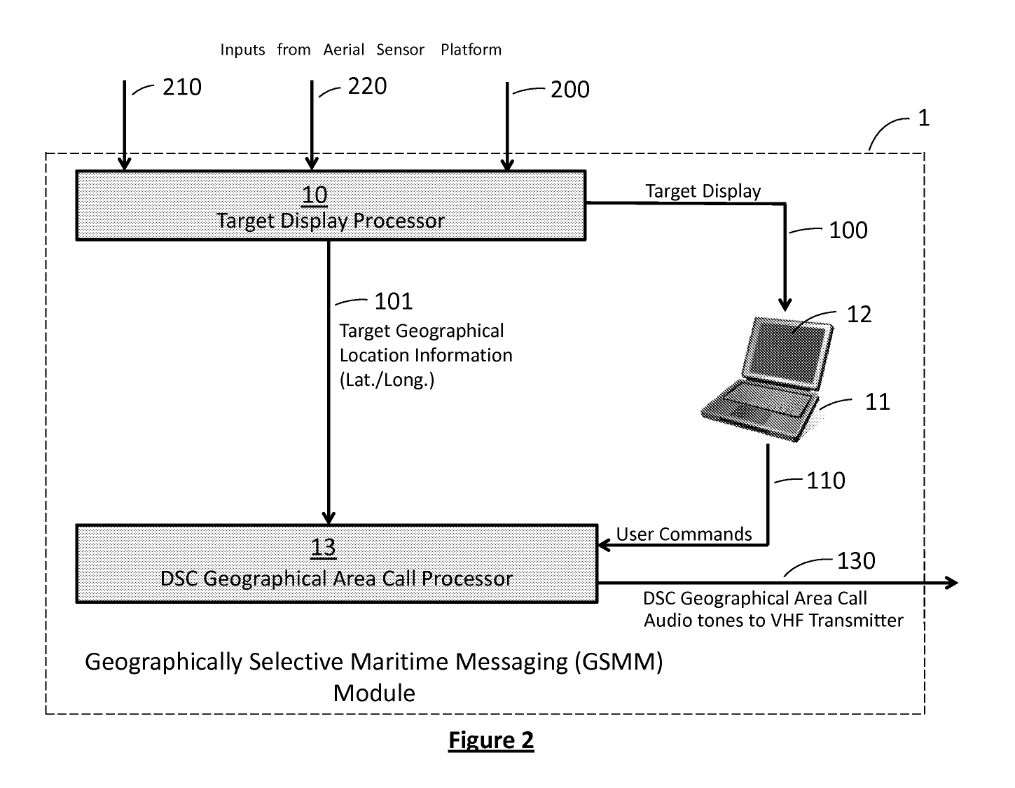

The GSMM Module 1 shown in FIG. 2 is the essence of the present invention. The Target Display Processor 10 accepts inputs 200, 210, and 220 from the Aerial Sensor Platform 2 and outputs the composite signal labeled Target Display 100 to the Human Machine Interface (HMI) 11. Target Display Signal 100 consists of an icon representing the aerial sensor platform's position and an icon representing the target vessel's position overlaid on an electronic nautical chart. Video of the target vessel is also supplied as part of the composite Target Display Signal 100 to the HMI 11 and displayed on HMI Display 12. Target Display Processor 10 also outputs the target vessel's geographical location, in degrees latitude and longitude, to the DSC Geographical Area Call Processor 13. If enabled by User Command signal 110, the DSC Geographical Area Call Processor 13 will encode the target vessel's geographical position into a DSC Geographical Area Call sequence as specified by ITU-R M.493 (series). The DSC Geographical Area Call sequence 130 is sent to a VHF radio 3 where it modulates a carrier frequency and is transmitted over the air with an effective range of approximately 25 nautical miles.

DSC protocols and call formatting are set forth in ITU-R M.493 as follows: The DSC system is a synchronous system using characters composed from a ten-bit error-detecting code. The first seven bits of the ten-bit code are information bits. Bits 8, 9 and 10 indicate, in the form of a binary number, the number of B elements that occur in the seven information bits, a Y element being a binary number 1 and a B element a binary number 0. The order of transmission for the information bits is least significant bit first but for the check bits it is most significant bit first. Time diversity is provided in the call sequence as follows: Apart from the phasing characters, each character is transmitted twice in a time-spread mode; the first transmission (DX) of a specific character is followed by the transmission of four other characters before the re-transmission (RX) of that specific character takes place, allowing for a time-diversity reception interval of 33⅓ ms for VHF radio-telephone channels. The classes of emission, frequency shifts and modulation rates are as follows: Frequency modulation with a pre-emphasis of 6 dB/octave (phase modulation) with frequency-shift of the modulating sub-carrier for use on VHF channels. Frequency-shift between 1300 and 2100 Hz; the sub-carrier being at 1700 Hz; the frequency tolerance of the 1300 and 2100 Hz tones is ±10 Hz; the modulation rate is 1200 Baud; the index of modulation is 2.0±10%.

ITU information specific to the Geographical Area Call: Geographical area entry DSC equipment should be provided with means for transforming a geographical area specified by the user as a center point and a range to the corresponding Mercator area call format specified. The transformation of the entered range and center-point should result in the minimum rectangular area that encompasses the entered data.

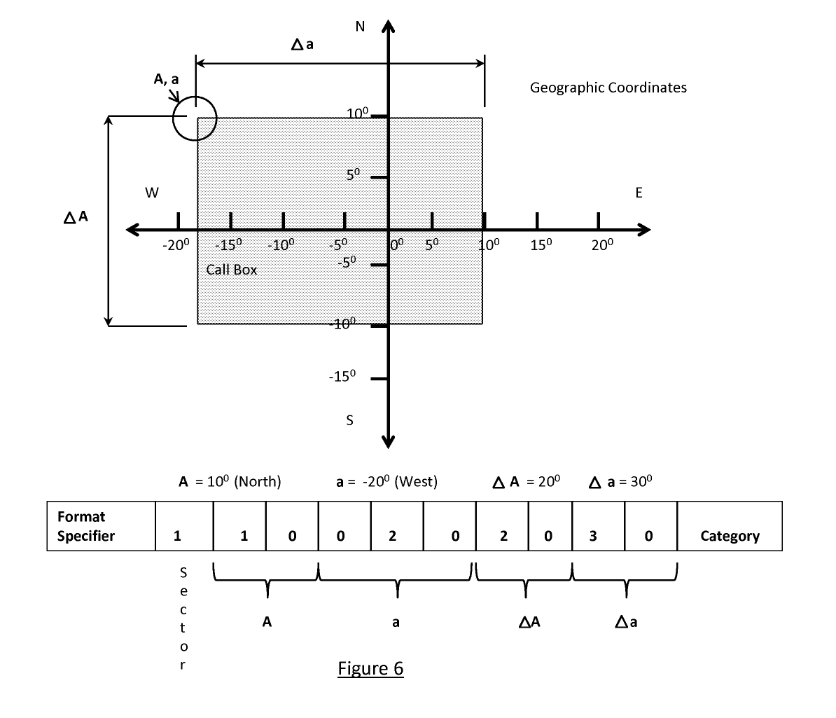

FIG. 6 from ITU-R M.493.11 depicts how a desired geographic “call box,” encompassing the subject vessel, is formatted and digitally encoded. When such a Geographical Area Call is transmitted, only those DSC-capable radios located within the boundary of the call box will decode the transmission and alert the operator by ringing. The transmission will be transparent to all vessels outside the boundary of the call box. ITU-R M.493 only allows for call box resolution in one degree increments, or roughly 60 miles per side. This is not practical since the call box would encompass many unintended vessels. One method to address this shortcoming is by reducing the transmitter output power and employing radiation pattern beamforming techniques with directional antennas. ITU M.821 allows for a DSC expansion sequence, which improves resolution to one minute increments, or about one mile per side.

The receiving DSC radio, upon receiving and decoding the Geographical Area Call on 156.525 MHz (Ch. 70), alerts the radio operator that another party is attempting to initiate radio communications. Per ITU-R M.493, the receiving DSC radio automatically tunes to a pre-determined frequency for follow-on voice communications. Channel 70 is designated by the Federal Communications Commission (FCC) as a “digital messaging only” frequency; no voice communications are permitted.

The VHF radio 3 that broadcasts the DSC Geographical Area Call is controlled by the GSMM Module 1. To initiate a DSC transmission, the HMI 11 sends a transmit enable signal as a User Command 110 through the DSC Geographical Area Call Processor 13 to the VHF radio 3. The User Command 110 to transmit a DSC Geographical Area Call can be initiated by the HMI 11 either manually by an operator or automatically.

### BEST MODE OF OPERATION OF INVENTION

The GSMM process is scalable and easily adaptable to a wide variety of applications. Three manifestations of the GSMM process are outlined here:

Force protection. In this scenario, the Aerial Sensor Platform 2 is an airborne UAV patrolling the perimeter of a formation of military vessels. The GSMM Module 1 and VHF radio 3 are located aboard one of the military vessels. An operator monitors displayed target vessels on the HMI Display 12 to ensure they do not encroach upon the established security perimeter. If the operator detects a possible Small Vessel Threat (SVT), a User Command 110 is initiated to the DSC Geographical Area Call Processor 13 and a DSC Geographical Area Call 130 sequence is sent to the VHF radio 3 and transmitted on DSC channel 70, 156.525 MHz. The target vessel's DSC radio “rings” alerting the operator that someone desires to establish voice communications on a predetermined frequency. Both operators switch to a “working” radio frequency and the GSMM operator communicates that the target vessel has intruded inside the security perimeter. The target vessel backs away from the formation of military vessels.

Port Security. In this scenario, the Aerial Sensor Platform 2 is a fixed tower or tall building with unobstructed views of a port, harbor, or waterway. The GSMM Module 1 is located in a U. S. Coast Guard Command Center and the VHF radio 3 is part of the Coast Guard's Rescue 21 communications network. In this configuration, since the aerial platform is fixed the GPS Receiver 21 could be eliminated by manually entering the platform's latitude, longitude, and altitude information directly into the Target Position Processor 22. An operator defines geographical boundaries, or “geo-fences,” on the electronic navigational chart using the HMI 11 and HMI Display 12. An OE/IR sensed vessel crosses the virtual geo-fence and triggers a User Command 110. The DSC Geographical Area Call Processor 13 receives the command and a DSC Geographical Area Call 130 sequence is sent to the VHF radio 3 and transmitted on DSC channel 70, 156.525 MHz. The target vessel's DSC radio “rings” and boater switches his radio to a voice frequency to hear instructions from the Coast Guard.

Autonomous Operation. In this last scenario, the GSMM Module 1 and VHF radio 3 are physically co-located on the Aerial Sensor Platform 2, which is a UAV. The EO/IR sensor system scans wide swaths of ocean below while the UAV flies a pre-established flight pattern. The HMI 11 has been programmed to automatically generate User Command 110 and initiate a DSC Geographical Area Call to a target vessel. The onboard VHF radio 3 transmits the call on DSC Channel 70. The target vessel's DSC radio rings and the operator shifts to the requested voice frequency to hear a pre-recorded message.

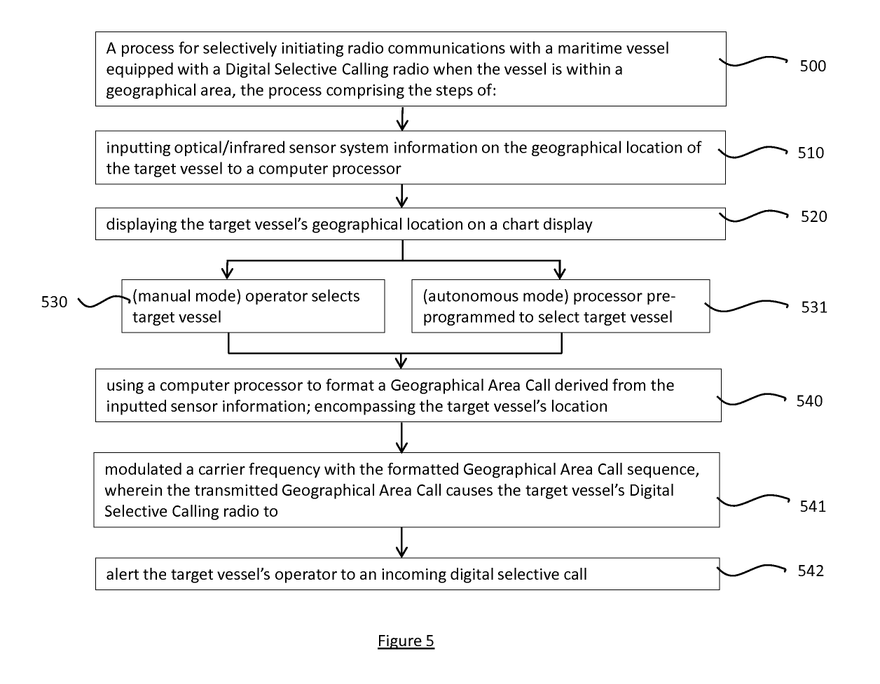

FIG. 5 is a flow diagram of the preferred embodiment of the invention; a process for selectively initiating radio communications with a maritime vessel equipped with a Digital Selective Calling radio when the vessel is within a geographical area 500. A Digital Selective Calling radio uses geographical area call formatting as set forth in the International Telecommunications Union's latest standard in the series designated ITU-R M.493.

A first step 510 comprises inputting the target vessel's geographical location, in degrees latitude and longitude, from an optical/infrared sensor system mounted on an aerial sensor platform. A second step 520 comprises displaying the target vessel on a Human/Machine Interface display as a computer icon. The target vessel's computer icon is displayed at the derived latitude and longitude on an electronic navigational chart.

An optional step 530 comprises an operator manually selecting a target vessel and sending a user command to the DSC Geographical Area Call processor. Optional step 531 comprises an automated mode of operation wherein a processor is pre-programmed to send a user command to the DSC Geographical Area Call processor without operator intervention.

Step 540 comprises using a computer processor to format a DSC Geographical Area Call sequence as set forth in ITU-R M.493. The Geographical Area Call “call box” shown in FIG. 6 is comprised using the target vessel's geographical location information 510.

Step 541 comprises modulating a VHF carrier frequency with the Geographical Area Call sequence 540 and transmitting the signal over the air to the target vessel's DSC radio. The target vessel's DSC radio will alert the operator to an incoming Digital Selective Call 542.

What is claimed is:

1. An apparatus for displaying optically sensed contacts in a maritime environment comprising:
a target display processor for obtaining detailed geographical location information from an external optical/infrared sensor system; and
a display for displaying an electronic navigational chart and icons representing target vessels.

2. An apparatus for initiating geographically selective radio communications comprising:
a human/machine interface for inputting operator commands; and
a geographical area call processor for generating a DSC geographical area call sequence.

3. The apparatus for displaying contacts according to claim 1, wherein the processor generates a computer icon representing the geographical location, latitude and longitude coordinates, of the sensed target vessel.

4. The apparatus for displaying contacts according to claim 1, wherein the processor generates a computer icon representing the geographical location, latitude and longitude coordinates, of the aerial sensor platform.

5. The apparatus for initiating geographically selective radio communications according to claim 2, wherein the human/machine interface is configured to accept manual input to generate a user command signal initiating a DSC geographical area call sequence.

6. The apparatus for initiating geographically selective radio communications according to claim 2, wherein the human/machine interface is configured to accept computer programming to automatically generate a user command signal initiating a DSC geographical area call sequence.

7. The apparatus for initiating geographically selective radio communications according to claim 2, wherein the processor generates a DSC geographical area call sequence encompassing the geographical location of the optically sensed target vessel.
